(19) United States
(12) Patent Application Publication
(10) Pub. No.: US 2026/0056074 A1
(43) Pub. Date: Feb. 26, 2026

(54) PRESSURE SENSOR

(71) Applicant: Murata Manufacturing Co., Ltd., Nagaokakyo-shi (JP)

(72) Inventors: Takahiro ASADA, Nagaokakyo-shi (JP); Yoshihiro YOSHIDA, Nagaokakyo-shi (JP); Takeshi NAKANISHI, Nagaokakyo-shi (JP)

(21) Appl. No.: 19/377,177

(22) Filed: Nov. 3, 2025

Related U.S. Application Data
(63) Continuation of application No. PCT/JP2024/017760, filed on May 14, 2024.

(30) Foreign Application Priority Data
Jun. 14, 2023 (JP) 2023-097641

(51) Int. Cl. G01L 19/14; G01L 9/00

(52) U.S. Cl. CPC G01L 19/141; G01L 9/0042; G01L 19/147

(57) ABSTRACT

A pressure sensor that includes a substrate; a detection element on a surface of the substrate; and a covering member on the surface of the substrate and covering a portion of the detection element. The covering member includes: a main body on the upper surface of the substrate, a protruding part protruding from a surface of the main body in a direction away from the substrate, and a recessed part recessed from a surface of the protruding part along an up-down direction and exposing the detection element. The recessed part has a taper shape in which an opening face becomes smaller in a direction from the surface of the protruding part toward the detection element. In a section, an inner wall surface of the recessed part is recessed outward from an imaginary straight line connecting an upper end portion and a lower end portion of the inner wall surface.

### CROSS REFERENCE TO RELATED APPLICATIONS

The present application is a continuation of International application No. PCT/JP2024/017760, filed May 14, 2024, which claims priority to Japanese Patent Application No. 2023-097641, filed Jun. 14, 2023, the entire contents of each of which are incorporated herein by reference.

### TECHNICAL FIELD

The present disclosure relates to a pressure sensor formed by using the technology of MEMS (Micro Electro Mechanical Systems).

### BACKGROUND ART

As a pressure sensor of such a type, for example, a pressure sensor described in Patent Document 1 has been known. The pressure sensor described in Patent Document 1 includes a substrate (base member), a detection element provided on the substrate, a covering member (resin package) provided on the substrate and covering the detection element. The covering member includes a main body part provided on the substrate and having a rectangular parallelepiped shape, a ring holding part having a columnar shape extending from an upper surface of the main body part in a direction away from the substrate, and a recessed part recessed from a top portion of the ring holding part toward the substrate and exposing a portion of the detection element.
Patent Document 1: U.S. Patent Application Publication No. 2022/0190230

### SUMMARY OF THE DISCLOSURE

The covering member is made of resin, for example, and is formed by a FAM (Film Assisted Molding) process that is a type of a transfer molding method. In the process, a lower mold on which the substrate is mounted and an upper mold disposed so as to sandwich the substrate between the upper mold and the lower mold are used. Resin is filled in the space between the substrate and the upper mold, and the covering member is thus formed on the substrate. A film is provided on a lower surface of the upper mold in advance to prevent the resin from adhering to the upper mold. For example, by being sucked through a suction hole provided in the lower surface of the upper mold, the film sticks to the lower surface.

However, the known pressure sensor has a problem that the film is hard to peel off from the covering member in the recessed part when the upper mold and the film are removed from the covering member after the covering member is formed.

Thus, an object of the present disclosure is to address the above-described problem and to provide a pressure sensor allowing easy peeling-off of a film from a covering member.

A pressure sensor according to the present disclosure includes: a substrate; a detection element on a surface of the substrate and configured to detect pressure; and a covering member on the surface of the substrate and covering a portion of the detection element, wherein the covering member includes: a main body on the surface of the substrate, a protruding part protruding from a surface of the main body in a direction away from the substrate, and a recessed part recessed from a surface of the protruding part along an up-down direction and exposing a portion of the detection element, the recessed part has a taper shape in which an opening face becomes smaller in a first direction away from the surface of the protruding part and toward the detection element, and in a section cut along the up-down direction, an inner wall surface of the recessed part is recessed outward from an imaginary straight line connecting an upper end portion and a lower end portion of the inner wall surface.

According to the present disclosure, there can be provided the pressure sensor allowing easy peeling-off of the film from the covering member.

### BRIEF DESCRIPTION OF THE DRAWINGS

FIG. 1 is a plan view of a pressure sensor according to a first embodiment of the present disclosure.

FIG. 2 is a sectional view of the pressure sensor in FIG. 1 taken along line II-II.

FIG. 3 is an enlarged sectional view of region EA1 of the pressure sensor in FIG. 2.

FIG. 4 is a sectional view illustrating an example of a manufacturing process of the pressure sensor in FIG. 2.

FIG. 5 illustrates a pressure sensor according to a second embodiment of the present disclosure and is an enlarged sectional view corresponding to region EA1 in FIG. 2.

FIG. 6 illustrates a pressure sensor according to a third embodiment of the present disclosure and is an enlarged sectional view corresponding to region EA1 in FIG. 2.

### DESCRIPTION OF THE PREFERRED EMBODIMENTS

<Findings that are Basis for Present Disclosure>

The inventors of the present disclosure obtained the following new findings as a result of diligent studies for providing a pressure sensor allowing easy peeling-off of a film from a covering member.

In the known pressure sensor, the recessed part has a taper shape in which an opening face becomes smaller as the opening face goes toward the base member in an up-down direction that is a thickness direction of the substrate. Specifically, the recessed part includes a bottom surface at which a portion of the detection element is exposed and an inner wall surface connecting the top portion of the ring holding part and the bottom surface to each other. The inner wall surface extends along the up-down direction.

In the above-mentioned FAM process, after the covering member is formed, the film moves upward along the up-down direction together with the upper mold to then be peeled off from the covering member. At this time, on the inner wall surface of the recessed part, the film moves along a planar direction, of the inner wall surface, along the up-down direction, thereby generating shearing resistance between the film and the inner wall surface. Thus, a portion of the film positioned on the inner wall surface is hard to move in the up-down direction and hard to peel off from the covering member.

Then, the inventors of the present disclosure conceived of a configuration in which a lower portion of the inner wall surface includes a portion whose angle relative to the up-down direction is increased, that is, a configuration in which, in a section along the up-down direction, the inner wall surface is recessed outward from an imaginary straight line connecting an upper end portion and a lower end portion of the inner wall surface. By increasing the angle of the lower portion of the inner wall surface relative to the up-down direction, the above-described shearing resistance is reduced, and the film thereby easily moves upward. As a result, peeling-off of the film from the covering member is facilitated. The inventors of the present disclosure have made the following disclosure based on the new findings.

Hereinafter, embodiments of the present disclosure will be described with reference to the drawings. Note that, although terms denoting specific directions or positions (such as terms including any one or more of “up”, “down”, “right”, and “left”) are used as needed in the following description, the use of such terms is for facilitating understanding of the present disclosure with reference to the drawings; thus, the technical scope of the present disclosure is not limited by the meanings of the terms. In addition, the following description is substantively merely an example and is not intended to limit the present disclosure, application thereof, or the use thereof. Moreover, the drawings are schematic, and the ratios of respective dimensions and the like do not necessarily match the actual ones.

In the present disclosure, the expression “electrically connecting or being electrically connected” means that a current can be conducted between plural constituent elements, means that plural constituent elements are capacitively coupled, and means that plural constituent elements are electromagnetically coupled.

### First Embodiment

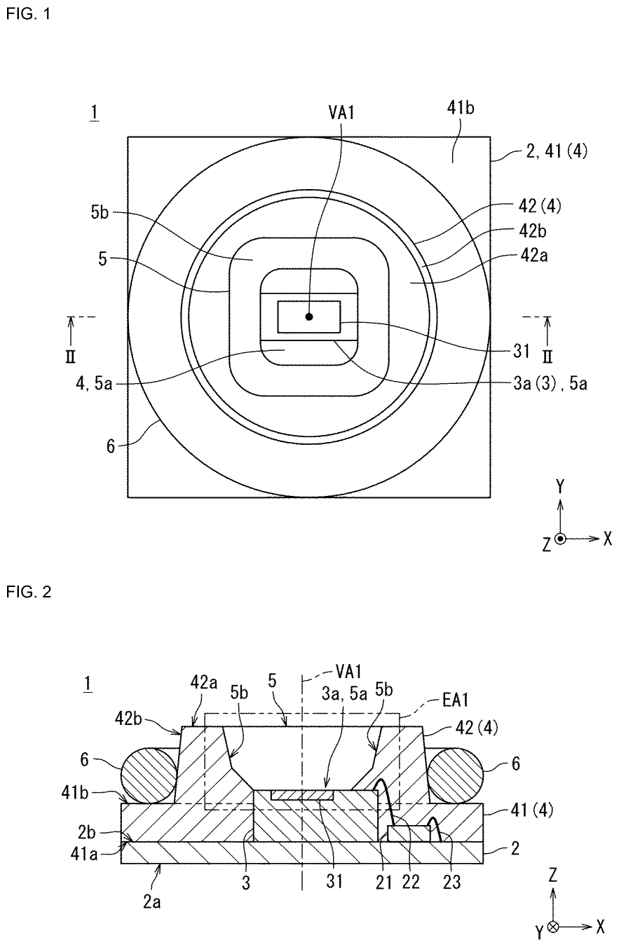

A pressure sensor according to a first embodiment of the present disclosure will be described with reference to FIGS. 1 and 2. FIG. 1 is a plan view of the pressure sensor according to the first embodiment of the present disclosure. FIG. 2 is a sectional view of the pressure sensor in FIG. 1 taken along line II-II. Although the drawings include the X-Y-Z rectangular coordinate system for convenience of description, the coordinate system is provided to facilitate understanding of the present disclosure and does not limit the present disclosure. Note that a Z direction in the coordinate system is an example of an “up-down direction” in the present disclosure.

As illustrated in FIGS. 1 and 2, a pressure sensor 1 includes a substrate 2, a detection element 3 provided on the substrate 2, and a covering member 4 provided on the substrate 2 so as to cover the detection element 3. The pressure sensor 1 measures pressure such as absolute pressure, gauge pressure, differential pressure, or airflow pressure.

As illustrated in FIG. 2, the substrate 2 includes a lower surface 2a and an upper surface 2b on the opposite side from the lower surface 2a. The substrate 2 is, for example, a wiring board, such as a resin substrate, a ceramic substrate, or a lead frame. In the present embodiment, the substrate 2 is a printed wiring board. As illustrated in FIG. 1, in the present embodiment, the substrate 2 is a square including sides extending in an X direction or a Y direction in a plan view in the Z direction.

As illustrated in FIGS. 1 and 2, the detection element 3 and a circuit element 21 are disposed on the upper surface 2b of the substrate 2. The detection element 3 is a pressure sensor element configured to detect pressure. For example, the detection element 3 is a piezo resistance pressure sensor element or an electrostatic capacitive pressure sensor element and is a MEMS (Micro Electro Mechanical Systems) element. In the present embodiment, the detection element 3 is formed into a rectangular parallelepiped and includes an upper surface 3a on the opposite side from a surface facing the upper surface 2b of the substrate 2. The detection element 3 includes a detection part 31 provided in or on the upper surface 3a and on which pressure acts. The detection part 31 is, for example, a membrane or a diaphragm for receiving pressure.

The circuit element 21 is, for example, an element including an ASIC (Application Specific Integrated Circuit). In the present embodiment, the circuit element 21 includes, for example, a converter configured to convert a voltage signal output from the detection element 3 into a digital signal, a filter configured to filter a digital signal from the converter, a temperature sensor configured to detect a temperature, a processor configured to correct a filtered digital signal based on a temperature detected by the temperature sensor, and a memory configured to store a correction factor and/or the like used in correcting a digital signal by using a detected temperature.

In the present embodiment, the detection element 3 and the circuit element 21 are arranged in the X direction on the upper surface 2b of the substrate 2 as illustrated in FIG. 2. For example, each of the detection element 3 and the circuit element 21 is joined to the substrate 2 with an adhesive member such as a die attach film or a die bond material therebetween.

In the present embodiment, the detection element 3 and the circuit element 21 are connected to each other with a bonding wire 22, extending from the upper surface 3a of the detection element 3, therebetween. In addition, the circuit element 21 and the substrate 2 are connected to each other with a bonding wire 23, extending from a surface of the circuit element 21, therebetween. Thus, the circuit, the detection element 3, and the circuit element 21 that are provided in or on the substrate 2 are electrically connected to one another.

Note that the detection element 3 and the circuit element 21 may also be electrically connected to each other with the circuit of the substrate 2 therebetween. For example, each of the detection element 3 and the circuit element 21 may also be connected to the circuit of the substrate 2 with a bonding wire or a bump therebetween. In addition, the detection element 3 and the circuit element 21 may also be stacked in the Z direction on the substrate 2.

The covering member 4 is provided on the upper surface 2b of the substrate 2 and covers a portion of the detection element 3, the circuit element 21, and the bonding wires 22 and 23. The covering member 4 includes a main body 41 provided on the upper surface 2b of the substrate 2 and a protruding part 42 protruding upward from the main body 41 along the Z direction. The main body 41 includes a lower surface 41a facing the substrate 2 and an upper surface 41b on the opposite side from the lower surface 41a. The protruding part 42 protrudes from the upper surface 41b of the main body 41. In the present embodiment, the covering member 4 is made of resin. The main body 41 and the protruding part 42 are formed into one body. In FIG. 2 and FIGS. 3 to 6, which will be referred to later, the broken line represents the boundary between the main body 41 and the protruding part 42.

The main body 41 and the protruding part 42 each have, for example, a circular shape, an elliptic shape, or a polygonal shape in a plan view.

As illustrated in FIGS. 1 and 2, the main body 41 is a rectangular parallelepiped in the present embodiment and is provided on the entire upper surface 2b of the substrate 2.

The protruding part 42 has a truncated cone shape tapering upward along the Z direction. The protruding part 42 includes an upper surface 42a that is a top surface and an outer wall surface 42b connecting the upper surface 42a and the upper surface 41b of the main body 41 to each other.

As illustrated in FIGS. 1 and 2, an O-ring 6 may be provided on the upper surface 41b of the main body 41 so as to surround the protruding part 42 in a plan view. The O-ring 6 is constituted by, for example, an elastic member such as rubber or silicon. The O-ring 6 may be provided around the protruding part 42 while stretched, and may be in contact with the outer wall surface 42b of the protruding part 42. In this case, when the pressure sensor 1 is attached to an electronic device, the O-ring 6 may be used for suppressing moisture from flowing into the space between a housing of the electronic component and the pressure sensor 1 by being flattened and elastically deformed between the housing of the electronic component and the pressure sensor 1.

The covering member 4 includes a recessed part 5 recessed downward from the upper surface 42a of the protruding part 42 along the Z direction and exposing a portion of the detection element 3. For example, the recessed part 5 exposes the detection part 31 of the detection element 3. That is, the covering member 4 covers the detection element 3 with a portion thereof except the recessed part 5.

As illustrated in FIG. 2, in the present embodiment, the recessed part 5 has a taper shape in which an opening face becomes smaller as the opening face goes away from the upper surface 42a of the protruding part 42 in the Z direction. In the present embodiment, the recessed part 5 is formed into a rotation symmetric shape about an imaginary central axis VA1 extending along the Z direction. The opening face of the recessed part 5 has a substantially rectangular shape whose corner portions are rounded in a plan view.

The recessed part 5 includes a bottom surface 5a at which the detection element 3 is exposed and an inner wall surface 5b connecting the bottom surface 5a and the upper surface 42a of the protruding part 42 to each other. The entire bottom surface 5a may be constituted by the upper surface 3a of the detection element 3, or, as illustrated in FIG. 1, a portion of the bottom surface 5a may be constituted by the upper surface 3a, and the remaining portion of the bottom surface 5a may be constituted as a surface of the covering member 4.

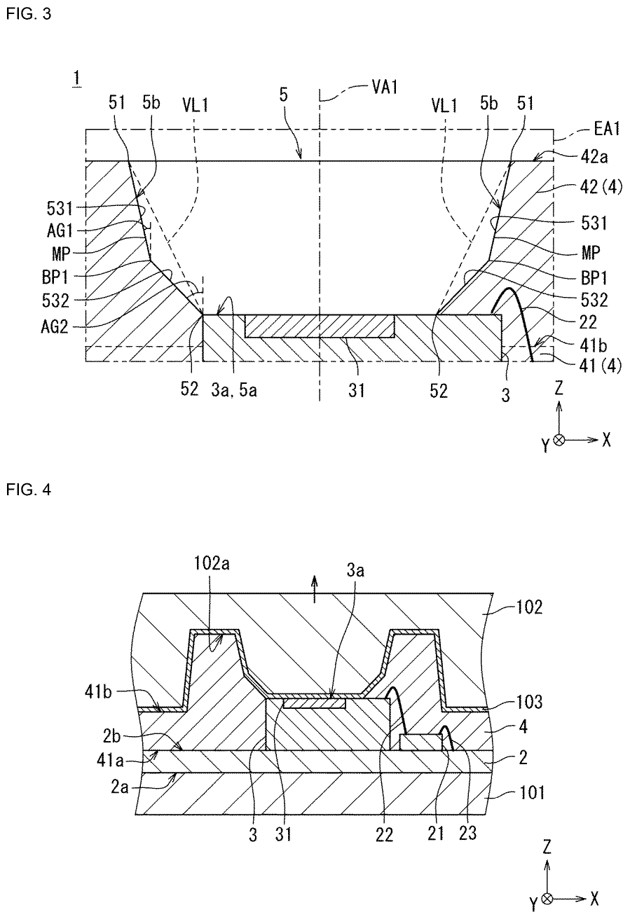

The shape of the inner wall surface 5b of the recessed part 5 will be described with reference to a section, in FIGS. 2 and 3, cut along the Z direction (hereinafter, also referred to as a “cut surface”). FIG. 3 is an enlarged sectional view of region EA1 of the pressure sensor in FIG. 2. In the present embodiment, the cut surface is a surface cutting the recessed part 5 and including the imaginary central axis VA1. The cut surface may also be a surface cutting the recessed part 5 without passing through the imaginary central axis VA1.

As illustrated in FIG. 3, in the cut surface, the inner wall surface 5b of the recessed part 5 includes an upper end portion 51 that is a connection portion to the upper surface 42a of the protruding part 42 and a lower end portion 52 that is a connection portion to the bottom surface 5a. The inner wall surface 5b is recessed outward from an imaginary straight line VL1 connecting the upper end portion 51 and the lower end portion 52 to each other. The expression “outward” here means a direction directed radially away from the imaginary central axis VA1 in a plan view. In the present embodiment, in the cut surface, the entire inner wall surface 5b is recessed outward from the imaginary straight line VL1.

The inner wall surface 5b is bent at least at one place in the cut surface. In the first embodiment, the inner wall surface 5b is bent at one place that is a bend position BP1. In the first embodiment, the bend position BP1 is at or below a midpoint MP between the upper end portion 51 and the lower end portion 52 of the inner wall surface 5b in the Z direction.

The inner wall surface 5b includes plural divided portions divided with the bend position BP1 as the boundary. In the present embodiment, the inner wall surface 5b includes an upper divided portion 531 connected to the upper end portion 51 and a lower divided portion 532 connected to the lower end portion 52. The upper divided portion 531 and the lower divided portion 532 each have a linear shape in the cut surface.

In the cut surface, an angle AG2 of the lower divided portion 532 relative to the Z direction is larger than an angle AG1 of the upper divided portion 531 relative to the Z direction. Note that, in the following description, an angle of the inner wall surface 5b relative to the Z direction may be referred to simply as an angle of the inner wall surface 5b or an angle of the divided portion.

The FAM process that is an example of a forming method of the covering member 4 in the pressure sensor 1 will be described with reference to FIG. 4. FIG. 4 is a sectional view illustrating an example of a manufacturing process of the pressure sensor in FIG. 2.

In the process, the covering member 4 is formed by using two molds that are a lower mold 101 and an upper mold 102. In the forming process of the covering member 4, a collective board in which a large number of the substrates 2 are arranged in a planar direction is disposed on the lower mold 101. FIG. 4 illustrates a portion, in the collective board, corresponding to one pressure sensor 1. The substrate 2 on the lower mold 101 is provided with the detection element 3, the circuit element 21, the bonding wires 22 and 23, and the like.

The upper mold 102 is disposed above the lower mold 101 so as to sandwich the substrate 2 between the upper mold 102 and the lower mold 101. The upper mold 102 includes a lower surface 102a facing the lower mold 101 in the Z direction. The lower surface 102a has a shape corresponding to the shape of the covering member 4.

A film 103 for preventing the resin for constituting the covering member 4 from adhering to the upper mold 102 is provided on the lower surface 102a. The film 103 is sucked toward the lower surface 102a through a suction hole (not illustrated) opened in the lower surface 102a of the upper mold 102. The film 103 is, for example, a release film containing Teflon (registered trademark).

The resin for constituting the covering member 4 is poured into the space between the substrate 2 and the upper mold 102 (specifically, the film 103). The resin that has been poured into the space is cured into the covering member 4. FIG. 4 illustrates the resin in a cured state.

Subsequently, the upper mold 102 moves upward along the Z direction as the arrow in FIG. 4 indicates. At this time, the film 103 also moves upward together with the upper mold 102 to then be peeled off from the cured covering member 4.

According to the pressure sensor 1 according to the first embodiment, in the cut surface, the inner wall surface 5b of the recessed part 5 is recessed outward from the imaginary straight line VL1 connecting the upper end portion 51 and the lower end portion 52 of the inner wall surface 5b. According to the above-described configuration, the angle of the inner wall surface 5b can be increased in a lower portion of the inner wall surface 5b (for example, the lower divided portion 532), compared with a configuration in which the inner wall surface 5b is not recessed outward from the imaginary straight line VL1. Thus, in the lower portion of the inner wall surface 5b, the shearing resistance generated between the inner wall surface 5b and the film 103 is reduced, and the film 103 is thereby easily peeled off from the covering member 4. Accordingly, there can be provided the pressure sensor 1 allowing easy peeling-off of the film 103 from the covering member 4.

In addition, since the inner wall surface 5b is recessed outward from the imaginary straight line VL1, in the cut surface, the angle of an upper portion of the inner wall surface 5b (for example, the angle AG1 of the upper divided portion 531) is smaller than the angle of the lower portion of the inner wall surface 5b (for example, the angle AG2 of the lower divided portion 532). Thus, the opening face of the recessed part 5 in the upper surface 42a of the protruding part 42 can be suppressed from becoming large, compared with a configuration in which the entire inner wall surface 5b is at the same angle as the lower portion of the inner wall surface 5b. Accordingly, the dimensions of the protruding part 42, the covering member 4, and the pressure sensor 1 in an XY direction can be suppressed from increasing.

In addition, by increasing the angle of the lower portion of the inner wall surface 5b, the dimension between the lower portion of the inner wall surface 5b (for example, the lower divided portion 532) and the outer wall surface 42b of the protruding part 42 in the XY direction (hereinafter, also referred to as a “wall thickness of a lower portion of the protruding part 42”) is increased compared with the known pressure sensor. Thus, the mechanical strength of the lower portion of the protruding part 42 is increased. The lower portion of the protruding part 42 here refers to a portion, in the protruding part 42, positioned between the lower portion of the inner wall surface 5b and the outer wall surface 42b in an orthogonal direction to the Z axis.

Such increase in the mechanical strength of the lower portion of the protruding part 42 improves the durability of the protruding part 42 against the pressure applied to the outer wall surface 42b from the O-ring 6 due to the elasticity of the O-ring 6. In addition, the external impact on the protruding part 42 is hard to transmit to the detection element 3, and the precision of the pressure detected by the detection element 3 is thereby improved.

In addition, since the wall thickness of the lower portion of the protruding part 42 is large, in the forming process of the covering member 4, the upper mold 102 is hard to bring into contact with members to be covered with the covering member 4, such as the bonding wires 22 and 23, even when the position of the upper mold 102 in the XY direction is off the predetermined position. In other words, the positional deviation tolerance of the upper mold 102 in the XY direction is increased, thereby facilitating the manufacture of the pressure sensor 1.

In addition, according to the pressure sensor 1 according to the first embodiment, the inner wall surface 5b is bent at least at one place in the cut surface. The upper mold 102 for forming the bent inner wall surface 5b can be easier to produce than an upper mold for forming an inner wall surface 5b including a wall surface that is smoothly curved without being bent. Thus, the manufacture of the pressure sensor 1 is facilitated compared with a configuration in which the inner wall surface 5b is not bent.

In the film 103, a portion positioned on the lower portion of the inner wall surface 5b is positioned on the deeper side of the recessed part 5 of the covering member 4 than a portion positioned on the upper portion of the inner wall surface 5b (refer to FIG. 4). Thus, the portion positioned on the lower portion of the inner wall surface 5b is even harder to peel off from the covering member 4 than the portion positioned on the upper portion of the inner wall surface 5b.

According to the pressure sensor 1 according to the first embodiment, the angle of the lower divided portion 532 is larger than the angle of the upper divided portion 531. That is, the angle of the inner wall surface 5b is increased in a region, in the inner wall surface 5b, where the film 103 is particularly hard to peel off. Thus, the ease of peeling-off of the film 103 from the covering member 4 is further improved.

In addition, according to the pressure sensor 1 according to the first embodiment, the bend position BP1 at the lowest level is at or below the midpoint MP between the upper end portion 51 and the lower end portion 52 of the inner wall surface 5b in the Z direction. Thus, the angle of a divided portion below the bend position BP1 (for example, the lower divided portion 532) can be increased compared with a configuration in which the bend position BP1 is above the midpoint MP. That is, the angle of the inner wall surface 5b can be increased in a region, in the inner wall surface 5b, where the film 103 is particularly hard to peel off. Thus, the ease of peeling-off of the film 103 from the covering member 4 is further improved.

### Second Embodiment

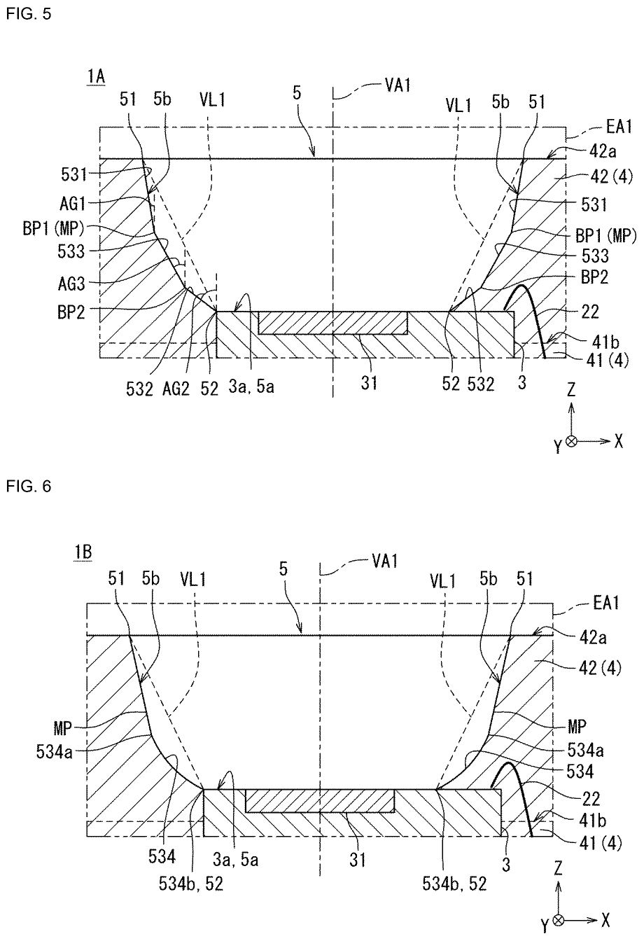

A pressure sensor according to a second embodiment of the present disclosure will be described with reference to FIG. 5. FIG. 5 illustrates the pressure sensor according to the second embodiment of the present disclosure and is an enlarged sectional view corresponding to region EA1 in FIG. 2.

A pressure sensor 1A according to the second embodiment differs from the pressure sensor 1 according to the first embodiment in that an inner wall surface 5b includes three or more divided portions in the cut surface. Note that, in the following description of the second embodiment, a constituent element similar to that of the pressure sensor 1 may be denoted by the same reference sign, and the description thereof may be omitted.

As illustrated in FIG. 5, in the cut surface, the inner wall surface 5b in the pressure sensor 1A is recessed outward from an imaginary straight line VL1 connecting an upper end portion 51 and a lower end portion 52 as with the pressure sensor 1 according to the first embodiment. The inner wall surface 5b is bent at two places that are a bend position BP1 and a bend position BP2 below the bend position BP1 in the Z direction.

For example, the bend position BP1 at the highest level in the inner wall surface 5b is at or below a midpoint MP between the upper end portion 51 and the lower end portion 52 of the inner wall surface 5b in the Z direction. In the present embodiment, the bend position BP1 is at the midpoint MP in the Z direction.

The bend position BP2 at the lowest level in the inner wall surface 5b is at or below the midpoint MP between the upper end portion 51 and the lower end portion 52 of the inner wall surface 5b in the Z direction. In the present embodiment, the bend position BP2 is below the midpoint MP in the Z direction.

In the cut surface, the inner wall surface 5b includes three divided portions divided with each of the bend positions BP1 and BP2 as the boundary. A portion, in the inner wall surface 5b, positioned above the bend position BP1 is an upper divided portion 531 connected to the upper end portion 51. A portion, in the inner wall surface 5b, positioned below the bend position BP2 is a lower divided portion 532 connected to the lower end portion 52. A portion, in the inner wall surface 5b, positioned between the bend position BP1 and the bend position BP2 is a middle divided portion 533. The divided portions 531 to 533 each have a linear shape in the cut surface.

In the cut surface, the angle, of any one selected from the three or more divided portions 531 to 533, relative to the Z direction is larger than the angle, of each of the divided portions positioned above the selected divided portion, relative to the Z direction. In other words, in the angle of each of the divided portions 531 to 533, the lower the divided portion is positioned in the Z direction, the larger the angle thereof.

Specifically, an angle AG2 of the lower divided portion 532 that is the divided portion at the lowest level is larger than both of an angle AG1 of the upper divided portion 531 and an angle AG3 of the middle divided portion 533 that are positioned above the lower divided portion 532. In addition, the angle AG3 of the middle divided portion 533 is larger than the angle AG1 of the upper divided portion 531 positioned above the middle divided portion 533. That is, in the angles AG1 to AG3 of the three divided portions 531 to 533, the angle AG2 of the lower divided portion 532 at the lowest level is the largest, and the angle AG1 of the upper divided portion 531 at the highest level is the smallest.

According to the pressure sensor 1A according to the second embodiment, in the angle of each of the divided portions 531 to 533, the lower the divided portion is positioned in the Z direction, the larger the angle thereof. According to this configuration, the lower the position in the inner wall surface 5b, the smaller the shearing resistance between the inner wall surface 5b and a film 103; thus, the film 103 is easily peeled off. Accordingly, the ease of peeling-off of the film 103 from a covering member 4 is further improved in a deep portion of a recessed part 5 where the film 103 is particularly hard to peel off.

### Third Embodiment

A pressure sensor according to a third embodiment of the present disclosure will be described with reference to FIG. 6. FIG. 6 illustrates the pressure sensor according to the third embodiment of the present disclosure and is an enlarged sectional view corresponding to region EA1 in FIG. 2.

A pressure sensor 1B according to the third embodiment differs from the pressure sensor 1 according to the first embodiment in that, in the cut surface, an inner wall surface 5b is not bent but includes a curved part instead. Note that, in the following description of the third embodiment, a constituent element similar to that of the pressure sensor 1 may be denoted by the same reference sign, and the description thereof may be omitted.

As illustrated in FIG. 6, in the cut surface, the inner wall surface 5b in the pressure sensor 1B is recessed outward from an imaginary straight line VL1 connecting an upper end portion 51 and a lower end portion 52 as with the pressure sensor 1 according to the first embodiment.

The inner wall surface 5b includes a curved part 534 protruding outward from the imaginary straight line VL1 in the cut surface. The curved part 534 includes a curved upper end portion 534a that is an upper end portion thereof and a curved lower end portion 534b that is a lower end portion thereof. In the present embodiment, the curved upper end portion 534a is positioned below a midpoint MP between the upper end portion 51 and the lower end portion 52 of the inner wall surface 5b in the Z direction. In addition, the curved upper end portion 534a is positioned outward from the imaginary straight line VL1 in the cut surface.

The curved lower end portion 534b constitutes the lower end portion 52 of the inner wall surface 5b in the cut surface. That is, the curved part 534 is connected to a bottom surface 5a of a recessed part 5.

An angle of the inner wall surface 5b in the curved part 534 is gradually increased downward. The angle of the inner wall surface 5b in the curved part 534 here is, for example, an angle of a tangent, at each position in the curved part 534, relative to the Z direction.

In the present embodiment, a portion of the inner wall surface 5b except the curved part 534 has a linear shape in the cut surface and is connected to the upper end portion 51.

According to the pressure sensor 1B according to the third embodiment, the inner wall surface 5b includes the curved part 534 protruding outward from the imaginary straight line VL1 in the cut surface. The angle of the inner wall surface 5b in the curved part 534 is gradually increased downward. Accordingly, in the curved part 534, the lower the position in the inner wall surface 5b, the smaller the shearing resistance between the inner wall surface 5b and a film 103; thus, the film 103 is easily peeled off.

In addition, as in the cases of the pressure sensors 1 and 1A according to the first and second embodiments, in the bent inner wall surface 5b, the angle of the inner wall surface 5b changes greatly above and below the bend position. On the other hand, in the curved part 534 of the pressure sensor 1B, the angle of the inner wall surface 5b changes gradually with the position in the Z direction. Thus, the ease of peeling-off of the film 103 from a covering member 4 is further improved.

In addition, according to the pressure sensor 1B according to the third embodiment, the curved lower end portion 534b constitutes the lower end portion 52 of the inner wall surface 5b. Thus, a lower portion of the curved part 534 whose angle relative to the Z direction is large is provided in a lower portion of the inner wall surface 5b (that is, a deep portion of the recessed part 5). Accordingly, the ease of peeling-off of the film 103 from the covering member 4 is further improved in the deep portion of the recessed part 5 where the film 103 is particularly hard to peel off.

Note that the present disclosure is not limited to the above-described embodiments and can be implemented in various other aspects. For example, although the recessed part 5 is formed into a rotation symmetric shape about the imaginary central axis VA1 in the above-described embodiments, the present disclosure is not limited thereto. For example, in a circumferential direction in a plan view, the inner wall surface 5b may be bent in a partial region and is not necessarily bent in the remaining region.

In addition, although the entire inner wall surface 5b is recessed outward from the imaginary straight line VL1 in the cut surface in the above-described embodiments, only a portion of the inner wall surface 5b may be recessed outward from the imaginary straight line VL1.

In addition, the bend position BP1 at the lowest level is at or below the midpoint MP in the above-described first embodiment but may also be above the midpoint MP. In addition, the bend position BP2 at the lowest level is at or below the midpoint MP in the above-described second embodiment but may also be above the midpoint MP.

In addition, the inner wall surface 5b is bent at two places in the cut surface in the above-described second embodiment but may also be bent at three or more places.

In addition, although the inner wall surface 5b is not bent in the cut surface in the above-described third embodiment, the present disclosure is not limited thereto. For example, the inner wall surface 5b may also be bent in a portion except the curved part 534.

In addition, although the curved upper end portion 534a is positioned below the midpoint MP in the above-described third embodiment, the present disclosure is not limited thereto. For example, the curved upper end portion 534a may also be positioned at or above the midpoint MP. In addition, the curved upper end portion 534a may also constitute the upper end portion 51 of the inner wall surface 5b. That is, the entire inner wall surface 5b may also be the curved part 534 in the cut surface.

By appropriately combining any ones of the above-described various embodiments or modifications, the respective effects thereof can be exhibited. In addition, a combination of embodiments, a combination of examples, or a combination of an embodiment and an example is possible, and a combination of features in different embodiments or examples is also possible.

Although the present disclosure has been sufficiently described in relation to the preferred embodiments with reference to the accompanying drawings, various modifications and alterations will be apparent to those skilled in the art. It should be understood that such modifications and alterations are included within the scope of the present disclosure according to the appended claims unless such modifications and alterations depart from the scope of the present disclosure.

The pressure sensor according to the present disclosure is useful as a variety of pressure sensors because peeling-off of the film from the covering member is facilitated.

### REFERENCE SIGNS LIST

1, 1A, 1B pressure sensor
2 substrate
2b upper surface
3 detection element
4 covering member
41 main body
41b upper surface
42 protruding part
42a upper surface
5 recessed part
5b inner wall surface
51 upper end portion
52 lower end portion
531 upper divided portion
532 lower divided portion
534 curved part
534b curved lower end portion
AG1, AG2 angle
BP1 bend position
MP midpoint
VL1 imaginary straight line

1. A pressure sensor comprising:
a substrate;
a detection element on a surface of the substrate and configured to detect pressure; and
a covering member on the surface of the substrate and covering a portion of the detection element, wherein the covering member includes:
a main body on the surface of the substrate,
a protruding part protruding from a surface of the main body in a direction away from the substrate, and
a recessed part recessed from a surface of the protruding part along an up-down direction and exposing a portion of the detection element,
the recessed part has a taper shape in which an opening face becomes smaller in a first direction away from the surface of the protruding part and toward the detection element, and
in a section cut along the up-down direction, an inner wall surface of the recessed part is recessed outward from an imaginary straight line connecting an upper end portion and a lower end portion of the inner wall surface.

2. The pressure sensor according to claim 1, wherein, in the section cut along the up-down direction, the inner wall surface is bent at least at one place.

3. The pressure sensor according to claim 2, wherein,
in the section cut along the up-down direction,
the inner wall surface includes a plurality of divided portions divided with a bend position as a boundary,
the plurality of the divided portions includes an upper divided portion connected to the upper end portion of the inner wall surface and a lower divided portion connected to the lower end portion of the inner wall surface, and
an angle of the lower divided portion relative to the up-down direction is larger than an angle of the upper divided portion relative to the up-down direction.

4. The pressure sensor according to claim 3, wherein,
in the section cut along the up-down direction,
the inner wall surface includes three or more of the divided portions, and
a first angle of any one selected from the three or more of the divided portions relative to the up-down direction is larger than a second angle of each of the divided portions positioned above the selected divided portion relative to the up-down direction.

5. The pressure sensor according to claim 2, wherein, in the section cut along the up-down direction, a bend position at a lowest level in the inner wall surface is at or below a midpoint between the upper end portion and the lower end portion of the inner wall surface in the up-down direction.

6. The pressure sensor according to claim 1, wherein, in the section cut along the up-down direction, the inner wall surface includes a curved part protruding outward from the imaginary straight line.

7. The pressure sensor according to claim 6, wherein, in the section cut along the up-down direction, a lower end portion of the curved part is the lower end portion of the inner wall surface.

8. The pressure sensor according to claim 1, wherein the recessed part has a rotation symmetric shape about an imaginary central axis extending along the up-down direction.

9. A pressure sensor comprising:
a substrate;
a detection element on a surface of the substrate; and
a covering member on the surface of the substrate and covering a portion of the detection element, wherein the covering member includes:
a main body on the surface of the substrate,
a protruding part protruding from a surface of the main body in a direction away from the substrate, and
a recessed part recessed from a surface of the protruding part in a direction toward the detection element and exposing a portion of the detection element, and
in a section view of the pressure sensor, an inner wall surface of the recessed part is recessed outward relative to an imaginary straight line connecting a first end portion and a second end portion of the inner wall surface.

10. The pressure sensor according to claim 9, wherein, in the section view of the pressure sensor, the inner wall surface is bent at least at one place.

11. The pressure sensor according to claim 10, wherein,
in the section view of the pressure sensor,
the inner wall surface includes a plurality of divided portions divided with a bend position as a boundary,
the plurality of the divided portions includes first divided portion connected to the first end portion of the inner wall surface and a second divided portion connected to the second end portion of the inner wall surface, and
an angle of the second divided portion relative to a thickness direction is larger than an angle of the upper divided portion relative to the thickness direction.

12. The pressure sensor according to claim 11, wherein,
in the section view of the pressure sensor,
the inner wall surface includes three or more of the divided portions, and
a first angle of any one selected from the three or more of the divided portions relative to the thickness direction is larger than a second angle of each of the divided portions positioned above the selected divided portion relative to the thickness direction.

13. The pressure sensor according to claim 10, wherein, in the section view of the pressure sensor, a bend position at a lowest level in the inner wall surface is at or below a midpoint between the first end portion and the second end portion of the inner wall surface in the thickness direction.

14. The pressure sensor according to claim 9, wherein, in the section view of the pressure sensor, the inner wall surface includes a curved part protruding outward from the imaginary straight line.

15. The pressure sensor according to claim 14, wherein, in the section view of the pressure sensor, a first end of the curved part is the second end portion of the inner wall surface.

16. The pressure sensor according to claim 9, wherein the recessed part has a rotation symmetric shape about an imaginary central axis extending along the thickness direction.
